(19) United States
(12) Patent Application Publication
(10) Pub. No.: US 2023/0252372 A1
(43) Pub. Date: Aug. 10, 2023

(54) MATERIAL DATAFLOW EXTRACTION AND SIMULATION SYSTEM

(71) Applicant: Purdue Research Foundation, West Lafayette, IN (US)

(72) Inventors: Shweta Singh, West Lafayette, IN (US); Carol X. Song, West Lafayette, IN (US); Venkata Sai Gargeya Vunnava, Indianapolis, IN (US)

(73) Assignee: Purdue Research Foundation, West Lafayette, IN (US)

(21) Appl. No.: 18/014,903

(22) PCT Filed: Jul. 6, 2021
(86) PCT No.: PCT/US21/40556

§ 371 Date: Jan. 6, 2023

Related U.S. Application Data
(60) Provisional application No. 63/048,482, filed on Jul. 6, 2020.

(51) Int. Cl. G06Q 10/063; G06Q 10/08

(52) U.S. Cl. CPC G06Q 10/063; G06Q 10/08

(57) ABSTRACT

System and methods for material dataflow extraction and simulation for bottom-up physical input-output table (PIOT) generation is provided. The system may receive an engineering model and an industry classification. The system may determine the type of engineering model. The system may execute the engineering model to generate the flow data. The system may build an physical supply use table (PSUT) for the region by determining, based on a flow type of data generated by the engineering model and the industry classification, a cell location in the PSUT. The system may store the data in the cell location of the PSUT. The system may generate a physical input output table (PIOT) based on PSUTs generated based for a plurality of industries.

### CROSS REFERENCE TO RELATED APPLICATIONS

This application claims the benefit of U.S. Provisional Application No. 63/048,482 filed Jul. 6, 2020, the entirety of which is hereby incorporated by reference.

### GOVERNMENT RIGHTS

This invention was made with government support under CBET-1805741 awarded by the National Science Foundation. The government has certain rights in the invention.

### TECHNICAL FIELD

This disclosure relates to economic modeling and, in particular, to physical mapping and material flow tracking using physical input output table networks.

### BACKGROUND

Input-Output (IO) methods have provided a robust framework for research in Industrial Ecology (IE) to map industrial and economic sector interconnections at multiple scales ranging from state, national, and global scale. The mapping of interconnections makes it possible to study cascading impacts in economy due to change(s) in one sector(s) or industry along with evaluating total environmental impacts using the environmentally extended Input-Output (EEIO) approach. One such IO based modeling technique is Physical Input-Output Tables (PIOTs), which provides a comprehensive accounting framework for tracking material flows from one economic sector to another and to the final end users. By doing so, PIOTs can help perform detailed Economy Wide Material Flow Accounting (EW-MFA) which provide insights in evaluating and improving our resource use efficiency. As PIOTs can help track commodities used, produced, emissions and waste flows for each sector, it provides a framework to map all the material flows in an economic region and provide a physical economy model for the region being studied. Some of the PIOTs applications include understanding the physical metabolism and structure of an economy, water energy nexus at regional city levels, tracking elemental flows across a regional physical economy, and modeling solid waste recycling. However, the true potential of PIOTs and their applications can be realized only if material flows are accounted at highly disaggregated economic sectors level. PIOTs developed using aggregated flows only provide minor improvements to conventional MFAs by allocating all the material flows in the economy to a few highly aggregated sectors. This aggregation gives rise to complications such as sector aggregation bias during material flow allocation as demonstrated in a recent study using EEIO by highlighting overestimation of raw-materials requirement in an analysis using aggregated biomass sector. Despite the known benefits of PIOTs, their development in a timely fashion for different regions of the world has been very slow. Specifically, tracking material flows at sub-national level or at highly disaggregated sector level using PIOTs is very rare except for a few studies that only track one or a few type of materials.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a first example of a system including a Material Flow Data Extractor and Simulation (MFDES) framework.

FIG. 2 illustrates example logic for a MFDES framework.

FIG. 3 illustrates an example of multiple simulator invocation.

FIG. 4 illustrates an example of a system including a cloud-based infrastructure.

FIG. 5 illustrates of a first user interface according to an example embodiment of a system.

FIG. 6 illustrates of a second user interface according to an example embodiment of a system.

FIG. 7 illustrates an example of a heat map generated based on a physical input output table.

FIG. 8 illustrates an example of a network generated based on a physical input output table.

FIG. 9 illustrates a third example of a system.

### DETAILED DESCRIPTION

Physical supply use tables (PSUTs) and physical input-output tables (PIOTs) provide a comprehensive view of how materials flow from one economic sector to another and to the end users. Since the PIOTs record transactions in physical units, they consider all the flows such as emissions and wastes which are generally not considered in monetary supply use tables and monetary input output tables. These emissions and waste flows are crucial in terms of environmental sustainability assessments and making decisions about recycling infrastructure and/or technologies. PSUTs and PIOTs provide a mechanism to map all the material flows in an economic region and provide a physical economy model for the region being studied. Moreover, PIOTs are often compatible with national accounts of economic flows and can also be used in conjunction with national level Material Flow Analysis. Furthermore, it is important to develop PSUTs and PIOTs at the most disaggregated levels possible to better investigate the intersectoral flows as it reduces uncertainty in decision making that arises from aggregation. For example, a highly aggregated PIOT can inform that transportation sector emits the highest amounts of greenhouse gases, but it cannot inform which sub-sector within the transportation sector as a whole is emitting the highest. Despite the known benefits of PSUTs and PIOTs, generation of these tables in a timely fashion for different regions of the world has been very slow. Specifically, sub-regional level tracking of materials flows using PSUTs and PIOTs is very rare except for 1 or 2 instances that only track one type of materials. This is mainly because, generating PSUTs and PIOTs at highly disaggregated levels has always been very challenging. The primary hurdles to build dis-aggregated PSUTs and PIOTs include reliable data availability, data heterogeneity, validation of the whole model, reproducibility of results for cross-checking and continuity for long term.

Previous approaches to national/sub-regional level PIOTs generally follow a top-down approach of processing the available national and sub-national level physical/monetary databases to build physical/monetary supply use tables using some form of optimization approach for disaggregation. Such tools automate the process of converting the available databases to supply use tables. A strength of these tools is that all the tools proposed are built to be highly compatible with large survey databases which makes these usable for all the data available in format used by these survey databases. However, the default assumption is that these datasets are always present and constrained by the data available in these surveys. This also implies that the tools will not work if these databases and surveys are discontinued in future and it will be difficult to capture the deep restructuring of our economic or physical systems, since surveys only capture the existing system at a given time, thus reducing the reliability for long term continuation and applicability of the model if the underlying structure changes drastically. For these reasons, we aim to complement these tools based on top-down approaches with a bottom-up approach-based tool that aims to utilize mechanistic knowledge of our physical system in automating the generation of PSUTs and PIOTs.

Accordingly, there is disclosed a system and methods for material dataflow extraction and simulation for bottom-up PIOT generation. By way of an introductory example, the system may follow a bottom-up approach in contrast to the existing tools that mostly follow a top-down approach. Unlike existing tools, the system is capable of handling fundamental bottom up processes that can directly be utilized to create physical supply use tables for the region being simulated.

The system may receive engineering models. The engineering models may include computer executable instructions written to simulate physical processes for different industries in an economy based on fundamental mass & energy balance and kinetics equations. When the engineering models are simulated to capture the scale at which an industry operates in a region, it enables the extraction of all relevant physical flow information required to build a highly accurate physical supply table for the region being simulated. The data from all the engineering models representing different industries in an economy can then be used to build physical supply use tables. The key in providing this functionality is the mapping of engineering models to respective supply and use tables.

The system and methods described herein overcome the limitations of dependence on survey-based databases that forms the foundation of the existing IE tools mentioned before. While system goes a step further and integrates engineering models to generation of PIOTs, it remains compatible to be integrated in future with other methodologies and build on the progress made so far specially the constrained optimization approaches to fill data gaps, utilizing the survey databases to reconcile results and comparative analysis from survey-based vs model-based results.

The system can simulate the engineering/mechanistic models developed for the different sectors in an economy and extract material flow data to build detailed physical supply use tables. By doing so, system provides a unique automated way to generate physical supply use tables. This functionality makes the system independent of survey dataset for all materials and can reliably capture these flows based on information on type of technology or mechanisms driving a physical economy. The system provides a technical advantage of faster adaptability to changes in underlying physical system functioning in any economy. This is because of the decoupling from static dataset and enabling simulating the physical data based on engineering models.

The end tables of all the methods in literature are static and provide a static snapshot of material flow network for the instance the data was collected/surveyed. The methodology used in development of the system and methods described herein can relay back real-time information from the engineering models to the latest physical supply use table generated. For example, if the fertilizer inputs for corn farming changes in the engineering model, then the physical use table can be modified in real-time to reflect the change in use patterns. This is another technical advantage of the system and methods described herein that makes it agile and very powerful for understanding the changing material flows in economic systems. Additional benefits, efficiencies, and improvements are made evident in the systems and methods described herein.

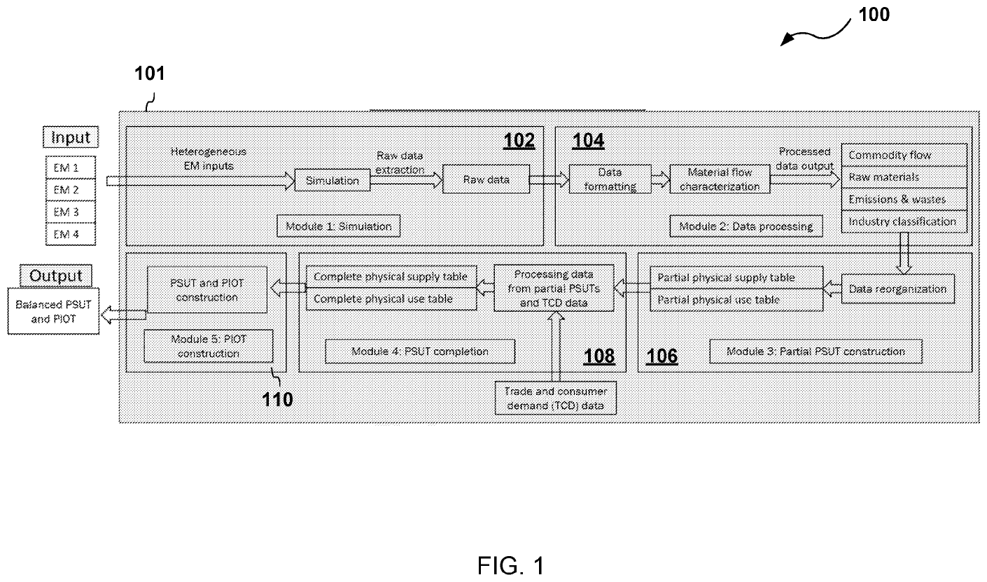

FIG. 1 illustrates a first example of a system including a Material Flow Data Extractor and Simulation (MFDES) framework 101. The MFDES framework 101 may include a simulation stage 102, a material flow characterization stage 104, a partial physical supply use table (PSUT) stage 106, a PSUT completion stage 108, and a physical input output table (PIOT) stage 110. Each of the stages may represent components or circuitry within the system and the term stage may be interchangeably referred to as circuitry or logical component.

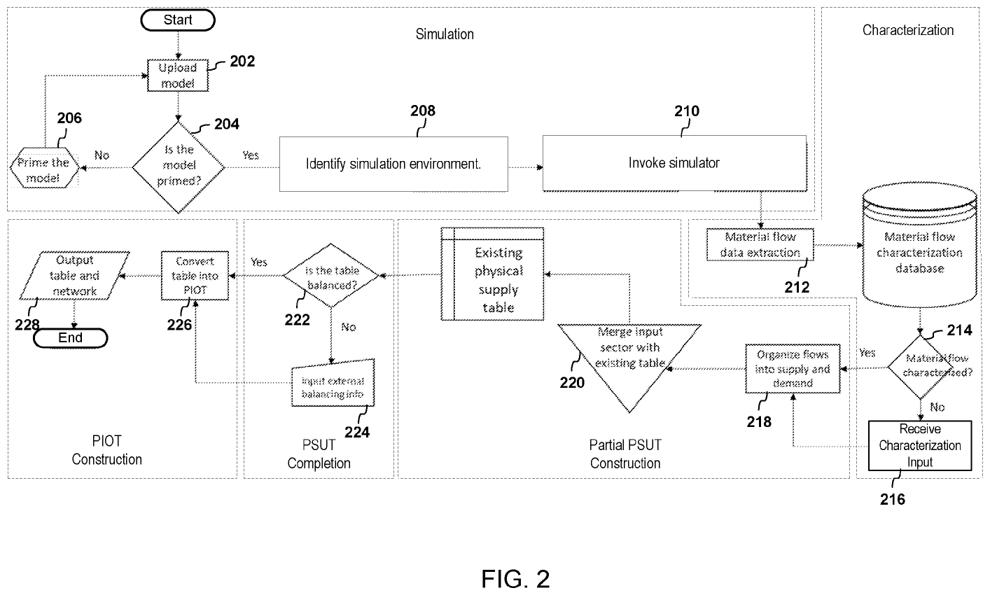

FIG. 2 illustrates example logic for the MFDES framework 101. Reference to FIG. 1 is made throughout the following discussion of FIG. 2.

### Simulation

The simulation stage receives different heterogeneous Ems generated with different modeling techniques and simulates them to get the raw data flow data from each model simulated. It is important to note that the heterogeneity of the Ems comes from the type data produced and the industry associated with the data, the type of executable code (i.e. python, ruby, c#, java, etc), and the format of the data, naming conventions, etc.

The heterogeneity of the Ems may be caused by differences in programming language rooted in how instructions are compiled and interpreted. For example, in some cases, a first EM may be a python script compiled using just-in-time (JIT) techniques whereas another EM script may be written in a different language compiled with JIT or more traditional techniques. Moreover, each programming language may require particular libraries, frameworks, and compilers to support complication and interpretation. Alternatively or in addition, the heterogeneity of the Ems may be rooted in differences in runtime environments. For example, each engineering model may execute in a different runtime environment. In other words, the environment in which management of application memory, variable access, parameter passing, and operating system interfacing may be different for each engineering model.

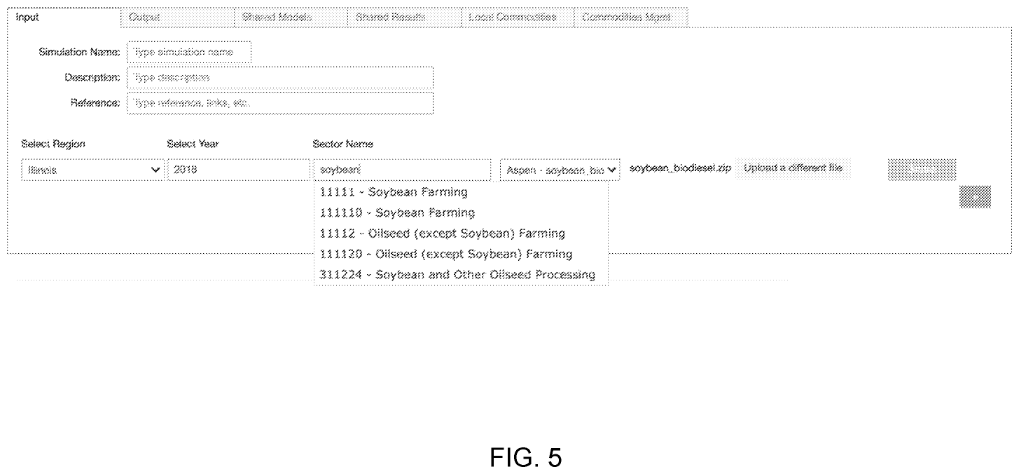

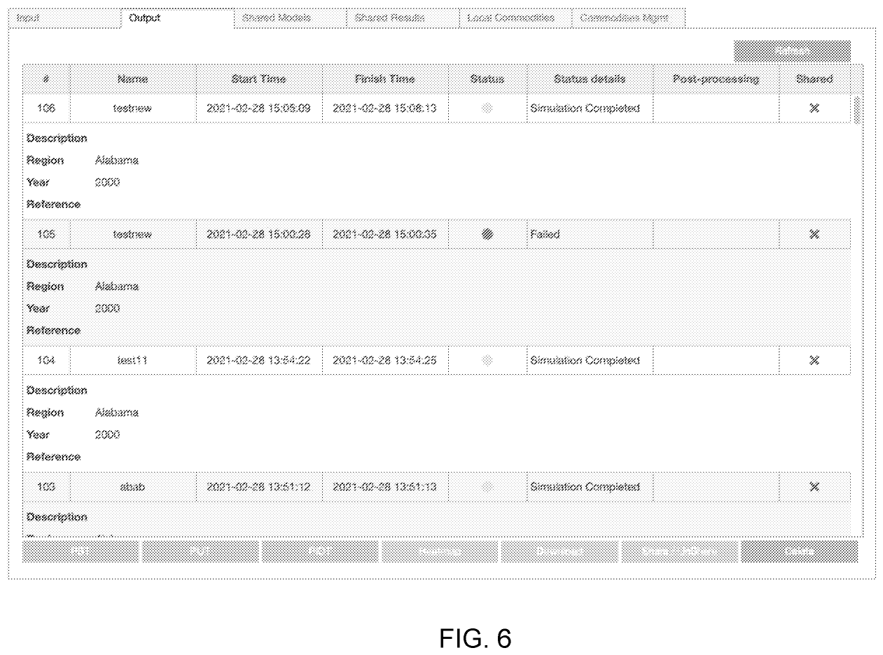

As shown in the logic in FIG. 2, a user may upload one or more engineering model via a user interface 202 (an example of a graphical user interface is shown in FIGS. 5-6). The MFDES may receive the model. The Ems received by the simulation stage may include executable code that generates material data flows. Each of the Ems that are input to module represent physical flows from different economic industries and/or sectors in a region. The heterogeneity of the EM models present technical challenges for implementing a bottom-up approach. Two areas that present significant challenges are differences in naming conventions, differences in programming languages, differences in run-time systems, differences in communications channels for providing the data flows. The differences in naming convention refers to how data flows are labeled differently between each EM module.

Although Ems are very good at representing the material transformation processes of various industries, they should be scaled appropriately so that they are also representative of the scale at which an industry operates in a region. There are various approaches that can be adopted for scaling based on industrial information or survey based datasets.

The simulation stage 102 may determine whether the simulation models are primed (204). In order to ensure that these models represent the physical flows in the economic region and MFDES can extract the relevant flows, the simulation stage 102 will prime the data into a format that MFDES can simulate (206).

Priming, which may also be referred to as pre-processing, involves modifying the EM's and/or establishing a data record that is used to access data flows generated by the Ems. For example, priming may involve changing the variable names used by the Ems, during compile time or runtime, used in the EM. Alternatively or in addition, the certain variable names (i.e. labels) may be flagged or labeled, and then stored for later access (e.g. as a Python object or a .CSV file). The labels may be associated with material flow data generated by the EM. As described herein, a variable name, or label, may refer to an identifier assigned to a group of data. For example, the variable name, or label, may refer to filled data structure, such as a column, of data stored in a memory.

For example, suppose an EM represents the biofuel industry. The EM may include a series of variable names representing different flows and sub-systems in the process of producing biofuels. To prime this EM, the variables containing relevant material flows are changed/edited and stored as python object or a .CSV file. MFDES then processes this information to keep track of the relevant flows picked during the priming process.

In some examples, the updated variable name or label associated with the variable may include information pertinent to later classification. Thus, the variable may have tags included in the name that identify the variable. The tags may include an industry classification tag and/or a datatype tag. The industry classification tag may correspond to codes used to identify the industry where the data belongs. For example the industry classification tag may include, for example, a code from the North American Industry Classification System (NAICS). The datatype tag may correspond to rows in a PSUT such as commodity flow, raw material, and waste/emission.

The selection of relevant dataflows may be performed by a user by modifying the script. Alternatively or in addition, the MFDES to select the dataflows based on variable names uploaded in a GUI. In other examples, the industry classification tags and/or flow type tags for a variable may be provided via the GUI. The variable names are provided in a metadata file for different types of models for users to prime their own models.

After the model is primed, the MFDES system may provide the model, and/or the resultant material flow data back to the user. The user may make modifications to the model then reupload the model. Alternatively, the MFDES may proceed directly to the next steps without user verification. In response to the EM(s) being primed, the primed models may be stored and/or provided as input to a simulator. Once Ems are primed and/or relevant metadata information is received, the simulator may execute the Ems and stores all the raw output data.

Simulating may involve identifying a simulation environment (208). The simulation stage 102 may prepare a variety of simulation environments. A simulation environment may include rules and/or frameworks for compiling, executing, and/or storing data. For example, a simulation environment may include a runtime environment compatible with the executable code of the engineering model. (ex: Aspen plus, Python, MATLAB, etc.). Each EM is simulated using a relevant EM simulator based on the file extension type or other information associated with the file provided by a user via a GUI.

For example, if EM1 is a python file, then MFDES recognizes the .py extension of the file and invokes a Python compiler and runtime environment to simulate the material flows for the industrial sector represented by EM1.

The simulation stage may invoke a simulator to execute one or more engineering models (210). Invoking different EM simulators and extracting the outputs of the simulated Ems for building PSUT/PIOT is a technical advancement not provided by traditional approaches. Invoking the simulator may involve initiating a procedural call to a simulation environment to cause execution of the instructions of an engineering model.

### Material Flow Characterization

Once the one or more Ems are simulated and raw data generated, the Material flow characterization stage may extract the material flow(s) generated by the simulator. The material flow characterization stage may first clean the raw data by stripping any simulator specific nonmaterial flow information. The simulator may have a schema that specifies how to parse the raw data into one or more dataflows. Each data flow may be associated with an industry classification, material flow type, and a flow direction.

The industry classification may have been previously provided via a graphical user interface. Industry classification names identify the industry being modeled in terms of their NAICS codes.

The flow type may include a commodity, raw material, emissions, and wastes. Commodity flows identify the different commodities that are supplied and used by industries. Raw material flows identify the material inputs from the nature to industries. Emissions & waste flows identify the material flows from industries to nature.

The flow direction may be based on whether a data flow as an input or an output to a particular engineering model. The input may correspond to a demand and the output may correspond to a supply.

The characterization stage interprets the nomenclature and/or schemas used by the models to identify different flows and selectively pick only the essential material flow information. The characterization stage may access predefined rules associated with the simulator and/or engineering model to parse the name assigned to the EM.

For example, the data flow stage may parse the EM's and identify the nomenclature used for identifying flows in the variable explorer section (input flows are tagged by ‘#0’ character and outputs are tagged by ‘#1’ character in Aspen Plus) of the model and picks only the input and output material flows and leaves out any intermediate flows in the model. After stripping and cleaning raw data from Aspen Plus models, MFDES looks for individual chemical constituents in each flow extracted and matches them with existing information in its database. Alternatively in addition, characterization stage may looks for variable tags used to mark material flows in the priming stage and extracts material flow information from the tagged variables after simulating them.

In some examples, the MFDES may include a database called Material Flow Characterization database (MFC) that contains the chemical composition of all commodities in the form of individual component and mass fractions. This database will be provided as default to users, however, as new models for additional materials are added to the system, this database may be updated. MFDES then calculates the mass fractions of all the material flows it extracts from the Ems and compares them with available mass fraction combinations. If there is a match, it assigns the name for the extracted material flow. If not, it will create a new material in the database and store the new mass fraction combinations.

In some examples, a label may be generated and associated with the flow data such that the flow type, direction and/or industry classification are embedded in the label. The label may include a variable name. The flow type, direction, and/or industry classification may be stored in the MFC database or some other repository that stores the flow data.

The characterization stage may determine whether a material flow is characterized (214). If a flow is not characterized, the MFDES system may receive a user characterization of the material flow (216) For example, a graphical user interface may provide control(s) to user for adding their commodities to the global database. These new commodities and it's composition may be peer reviewed before it is accepted. For example, if MFDES comes across a new user uploaded model that contains a novel biopolymer commodity for which no chemical composition information available in the MFC database, on approval by development team, MFDES appends this new information to the MFC database. Once appended, MFC will store the chemical mass fractions of the novel biopolymer and identify it in any future uploaded models that contain the same polymer. These newly characterized compositions are then readily available for all new PSTs, PUTs and PIOTs developed. It is intended that the MFC database grows as the user community uploading new shared Ems grows.

### Partial PSUT Construction

The partial PSUT construction stage 106 takes the data categorized in the four datatypes and reorganizes them in into supply and demand (218). For example, the data reorganization stage may store the data in the form of a physical use table (PUT) and a physical supply table (PST). An example of a PUT is shown in Table 1 and an example of a PST is shown in Table 2.

TABLE 1
Physical Use Table (PUT).

| | Industry Codes | | | | |
|---|---|---|---|---|---|
| Use Table | Code 1 | Code 2 | Code 3 | Exports | Final Demand |
| Commodity 1 | — | — | — | — | — |
| Commodity 2 | — | — | — | — | — |
| Commodity 3 | — | — | — | — | — |
| Natural Resource 1 | — | — | — | — | — |
| Natural Resource 2 | — | — | — | — | — |
| Total | — | — | — | — | |

TABLE 2
Physical Supply Table (PST)

| | Industry Codes | | | |
|---|---|---|---|---|
| Supply Table | Code 1 | Code 2 | Code 3 | Imports |
| Commodity 1 | — | — | — | — |
| Commodity 2 | — | — | — | — |
| Commodity 3 | — | — | — | — |
| Emission 1 | — | — | — | — |
| Waste 1 | — | — | — | — |
| Total | — | — | — | — |

As described herein, an PSUT refers to a combination of the PUT and the PST. It should be appreciated that a PUT and a PST may be stored as a PSUT, or as separate tables.

The MFDES system may identify, based on the flow type, flow direction, and industry classification, a cell location in the PSUT (or PUT and PST separately). For example, PSUT may include a physical supply table (PST) and a physical use table (PUT) (or the PST and PUT tables tables may be separate). The system may select the PST or PUT based on the flow direction. For example, the physical use table may be selected I response to the flow direction being an input to the engineering model. The physical supply table may be selected in response to the flow direction for a material flow being an output of the engineering model.

Within the PUT or PST, the, a cell location may be selected based on the industry classification (i.e. code 1, code 2, code 3, etc) and flow type (i.e. commodity, resource, waste, emission). As described herein, a cell location refers to a location in memory identified based on a memory address where data is stored in memory address according to a predefined set of rules of a data structure. In the present application, the PUT and PST are data structures.

The Partial PSUT construction stage may merge input sector with existing table 220. At this stage, system has the data required to build PSUTs except for the columns and rows related to exports, imports, and final customer demand. Hence at this stage, the PSUTs are only partially completed with information of supply and use of commodities by sectors in the economy. From this step, the tables can be used with the standard IO theory to generate balanced tables and perform further analysis.

### PSUT Completion

The PSUT completion stage 108 may determine whether the table(s) are balanced (222). The partial PSUTs are generally unbalanced as supply and use in an economy will not balance without inclusion of imports, exports and consumer use. These partially completed PSUTs need to be balanced with trade and consumer demand (TCD) data, that cannot be obtained from engineering models alone. However, from this step, the tables can be used with the standard 10 theory to generate balanced tables and perform further analysis, such as the balancing approaches suggested in the following works, which are hereby incorporated by reference:
Nicolardi, V. (2013, 12). Simultaneously balancing Supply-Use Tables at Current and Constant Prices: A new procedure. Economic Systems Research, 25 (4), 409-434.
Serpell, M. C. (2018, 4). Incorporating data quality improvement into supply use table balancing. Economic Systems Research, 30 (2), 271-288
Stanger, M. (2018). An Algorithm to Balance Supply and Use Tables (Vol. 18; Tech. Rep. No. 03). Statistics Department, International Monetary Fund.

Accordingly the PSUT completion stage 108 may input external balancing info (224). MFDES combines the partially completed PSUT with any available user specific trade (ex: state level import/export data) and consumer demand (TCD) data to build a complete PSUT. The missing information in the partially completed PSUTs may be filled by uploading enumerated files (such as .csv) containing missing information. These enumerated files may be uploaded to the MFDES tool just like any other Ems. But on recognizing the .csv file type, MFDES may not invoke any simulator for these files. Instead, the MFDES may identify the missing information and extracts the required information from the trade and consumer data to complete the PST and/or the PUT.

Since each column in the PST and PUT come from a mechanistically developed EM, all industry level balances are maintained as each EM ensures mass balances at industry level. If the underlying EM that represents an economic sector is accurately modeled to reflect the right material transformations taking place in that sector, the material flow information extracted from the EM will be representative of the actual flows in the economy. Therefore, care has to be taken that each material transformation in the EM used is validated before using in physical economy modeling. This means that the scope of errors or imbalances in the developed PSUTs is directly based on the errors or inaccurate modeling of Ems. If all the data is filled correctly, the PSUTs will be mostly balanced at individual industry level as industry input and output are from mechanistic models. We then check for commodity level balances after adding any available empirical information such as imports, exports, and final demand, the remaining imbalances are assigned to ROE to ensure mass balance. While the current framework used ensures overall mass input and output balances for all the sectors for which Ems exist, it cannot balance the flows for sectors which do not have Ems. To tackle this challenge, MFDES introduces a new column to represent the rest of the economy (ROE) that was not modeled, which is also used to balance the commodity supply and use in the economy. Finally, a slack variable was used to allocate imbalances that exist for the ROE column in the table to ensure a complete mass balance. We use the Eurostat model D method to transform any commodity level information in industry level information for export and final demand. For imports, since they come from outside the economy under study, the Partial PSUT construction stage may allocate the imported commodities to industries by weighting them with individual industry usage of the imported commodity. This process of balancing the PSUTs is automated and takes place in the PSUT completion stage. Finally, once PSUT balancing and construction is complete the results can be rendered to user and also passed on to PIOT construction.

### PIOT Construction

The PIOT construction stage 110 may convert PSTs and PUTs to PIOTs (226). The MFDES may transform the PUT and PST to PIOTs using a modified version of the Model D approach from the Eurostat manual. In this approach, the PSUTs are converted to PIOTs following matrix manipulation steps defined in the Model D approach. Other approaches defined in EUROSTAT manual can also be implemented.

The PIOT construction stage 110 may output the PIOT table and/or information derived from the PIOT table. A PIOT table may have first dimension and a second dimension where the first dimension represents flow of material to one or more sectors and the second dimensions corresponds material flow from one or more sectors. Thus, each cell within the PIOT table represents a unit of material flow from one sector to another sector. Table 3 illustrates an example of a PIOT.

TABLE 3
Physical Input Output Table Example

| | TO | | | |
|---|---|---|---|---|
| | Sector 1 | Sector 2 | Final Household | |
| FROM | (Code 1) | (Code 2) | Demand | Total Output |
| Sector 1 (Code 1) | 10 | 30 | 20 | 60 |
| Sector 2 (Code 2) | 15 | 20 | 5 | 40 |

This PIOT construction stage may also generate representations for visualizing the constructed PIOTs: 1) raw PIOT in .csv table format, 2) heatmap of the PIOT, and 3) weighted network. All the visualization forms are based on the raw PIOT constructed. MFDES uses the data from this raw PIOT and applies the data to different visualization program libraries encoded with the MFDES framework 101.

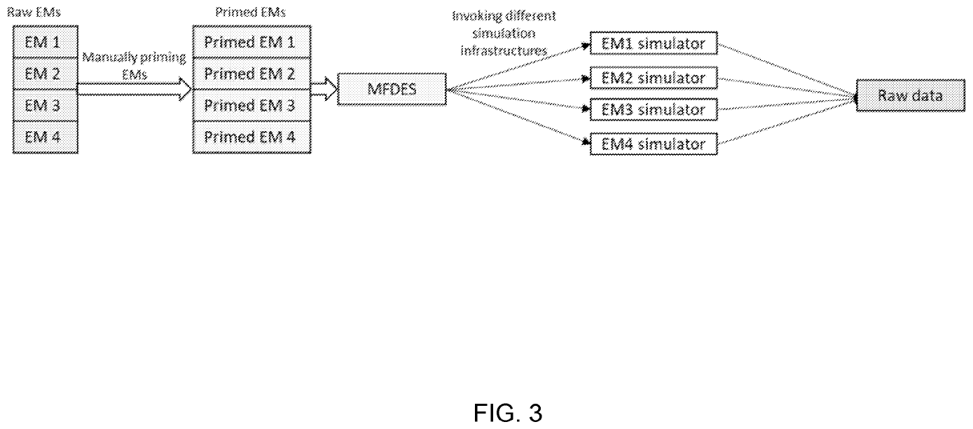

FIG. 3 illustrates an example of multiple simulator invocation. It should be appreciated that the MFDES framework 101 may run multiple jobs where multiple simulations are ran at once generating respective dataflows. The jobs may be ran concurrently, leveraging parallelism to achieve shorter execution times. Alternatively or in addition, the input flows of simulators may depend on the output flows of other simulators, the MFDES framework may coordinate multiple batches of job executions based on these dependencies.

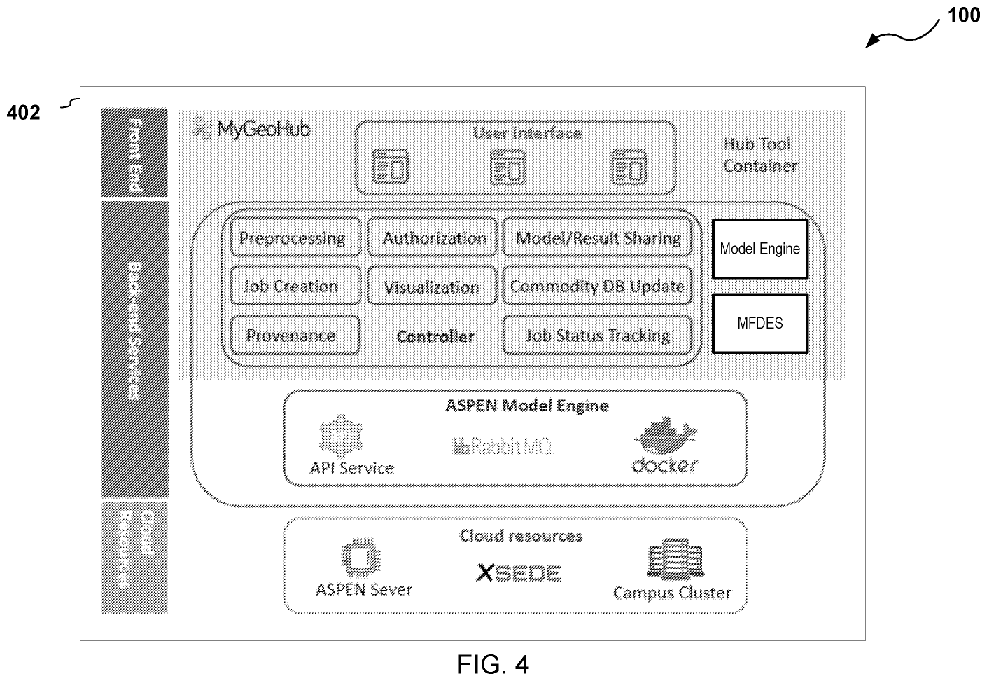

FIG. 4 illustrates an example of a system including a cloud-based infrastructure 402. The could-based infrastructure may make building PSTs, PUTs and PIOTs easily accessible and more collaborative by implementing the MFDES services. MFDES services may be deployed on a content management system.

There are several challenges in implementing the MFDES to map full economies. First, the system needs to support several types of input models commonly used by the community, including, but not limited to, open source python models, Aspen Plus models, and CSV files. Second, some software, such as Aspen Plus, runs on Windows while the rest of the system are Linux based. In addition, the such software may be proprietary with complex installation and set-up process. Third, users upload various modeling code as input for MFDES jobs. However, it poses a security risk to execute user-provided code on the server side, leading to system vulnerability to malicious attacks. Finally, when the size of the PIOT table grows, it could become data and computationally intensive, making it harder to scale to a large number of users or support a large number of industry segments.

The cloud-based system provides a modeling system to address these challenges. The cloud-based infrastructure 402 may provide a user interface that collects user inputs in a flexible format and presents PIOT, PST and PUT outputs in multiple ways. The cloud-based infrastructure 402 includes an easy to use GUI front-end built on the JN that is integrated with MFDES. Users can launch the JN instance in a virtual container on MyGeoHub to set input parameters or get results through a web browser. Once users set all of the required input parameters on the web, the information is submitted to the back-end services. The back-end PIOT services consist of four modules: (1) a python model engine that is responsible for executing python input models; (2) an Aspen Plus model engine that runs on a remote Aspen Plus server with a service API that accepts Aspen Plus model input and returns output after execution; (3) a controller that runs on MyGeoHub and is responsible for preprocessing user requests, creating MFDES jobs, dispatching the jobs to either the python engine or Aspen Plus engine, getting the results back, and merging the results in the MFDES job instances once all simulations are done; and (4) a visualization module for converting the outputs to tables or network diagrams.

In addition to mapping material flows and creating PIOTs, the could-based infrastructure may also support collaborative features such as model and result sharing among users. By default, models and outputs are private and only accessible by the owner. For the succeeded MFDES jobs, a user can easily share the results (PST, PUT, and PIOT tables, and visualization results such as heat-map and network images) with a single click. The basic provenance information of the results is automatically recorded and shared. The user can also add additional information about the results such as references. Once the results are shared, all the other users in the system can directly see the results or download the result files to their local machines. Similarly, a user can make their MFDES models public and accessible to others. The shared model can be directly used as an MFDES input or downloaded to users' machines so that they can see the details of the python/Aspen model code and modify it for a new MFDES job.

As previously discussed, MFDES maintains a database for commodities with their chemical compositions. Each file may describe the chemical composition of a commodity. When a user simulates a model with additional materials that do not exist in the default database, the MFDES database needs to be properly updated to include the new materials in a collaborative way. The commodity database in PIOT-Hub is maintained using a mechanism involving local and global commodity databases. In detail, once the controller finds new materials in a user job request, it appends a unknown marker tag, such as “\unknown” to the commodity names and stores them into the user's local commodity database after the job completes. The newly created materials persist on user's local database and could be renamed later from the user interface by the user. The user could issue a request to merge a new commodity into the global commodity database after specifying a meaningful commodity name. The cloud-based infrastructure 402 admin may get notified with the merge request and can authorize it from a tab of the cloud-based infrastructure 402 tool that is only accessible by admin users. The reason to keep separate databases (i.e., local and global) is to avoid issues where the same chemical composition could exist with different commodity names (i.e., duplication) or a commodity could have multiple versions with different chemical compositions (i.e., variation). Once the cloud-based infrastructure 402 admin approves the merge request, the local commodity name with its chemical composition is merged to the global commodity database and all the other users can use them in their MFDES jobs.

The front-end user interface and most of the back-end services including the controller and python model engine are built in Python using open source python packages such as Jupyter Widgets for GUI, Matplotlib/NetworkX for result visualization, and Numpy/Pandas for data processing. The service API on the Aspen Plus server is built using Javascript with Node.js, which provides an access point to the controller running on MyGeoHub for receiving simulation requests and sending the simulation results back. The Aspen Plus simulation engine manages the user requests through Docker containers and RabbitMQ for scalable and efficient data processing.

The cloud-based infrastructure 402 may be a usable, scalable, and secure online modeling environment. The system automatically detects the input model type and dispatches it to the corresponding back-end processing engine. Priming manual will be made available to help users prepare their models so that they comply with the format expectation of the tool. The cloud-based infrastructure 402 may runs python models on the hub server and Aspen Plus models on a remote Aspen Plus server. Aspen Plus backend services will be migrated in future to Linux server using windows VM support. Validation code is added to prevent malicious attack as well as to provide feedback to the user if the model fails to run. Furthermore, in each user session, the cloud-based infrastructure 402 runs in a secure virtual container on the HUBzero platform which helps mitigate the security risk as well.

When a user uploads a model, cloud-based infrastructure 402 will attempt to parse it and check if the model is primed and compatible with MFDES. The model will proceed to next stage if primed, if not, cloud-based infrastructure 402 will notify users that the model is not primed. A primed model will be handled by MFDES following all the steps in section 3 to generate PSTs, PUTs and PIOTs as shown in the demo next.

The cloud-based infrastructure 402 provides a platform that enables a faster generation of PIOTs using bottom-up approach implemented via MFDES which provides a network map of material flows in any region. The key of this platform is that it allows integration of mechanistic engineering models for physical economy using a bottom-up approach with the macroeconomic view of economy. Hence, it can also allow visualizing the material flow network change in real time. Few potential applications for are described below that can enable sustainable development in a region through automation of key steps required for analysis needed in decision making. The automation of such large-scale complex information required is another key novelty and unique strength of this tool, along with the adaptability and scalability for any region and any kind of new technology that will be developed in future.

Material Flow Maps to Identify Vulnerability in Production Systems in a Region due to Risks to a particular Industry: Once the physical economy of a region is modeled, it can be used to study the material intensities of different supply chains in the economy and trace everything back to unit process levels as MFDES uses a bottom-up approach. This can be used to identify the vulnerabilities for production in a region which can be used by plant managers and engineers to anticipate material supply challenges.

Material Flow Dynamics for Future Planning of Material Supplies: MFDES can also be used to simulate different scenarios as it makes it possible to study material flow dynamics. Based on the scenario being studied, MFDES can be used to generate a time series of material flow networks representing the different scenarios being studied. For example, the material consumption intensities of different supply chains can be quantified over the time duration during which a switch is being made from fossil fuel to renewable energy sources.

Automatically Identifying the Opportunities within Region for Circularizing Material Flows (Reducing Environmental Impact): Another important application of MFDES could be in the area of circular economy. If the physical economy of a region is modeled using MFDES from mechanistic models, it is possible to identify co-products/waste flows in one industry that can be used in another industry to increase the circularity of material flows. Additionally, a matching algorithm can be built that will give users recommendation of available waste materials that can be substituted for raw feedstock at a cheaper price. Based on the cloud-based information and geo-tagging of the materials available in region, users will be able to make decision about minimizing the cost of production and also minimizing overall waste in region, thus improving the local land/water/air quality.

Identifying the best Emerging Technology for Scale Up: This network view allows to visualize and simulate the impact of scale up of emerging technologies (such as new renewable energy systems, nanotechnology-based production, 3D printing) etc on overall changes in the material flow dependency. Hence, for a stakeholder it is easier to quantify the total impact on economy in terms of material flows before deciding to scale up. Further, this can also be used to design modular economies with several new processes and putting in risk management plan through network based simulation.

MFDES can be very useful for environmental policy makers as it helps in accounting relevant environmental flows between various industries and the nature. Since MFDES relies on mechanistic models to build PSUTS, flows such as CO2 emissions to air and Nitrogen/Phosphorus flows to water can be tracked and quantified at all stages during the material transformation of commodities.

FIG. 5 illustrates of a first user interface according to an example embodiment. FIG. 6 illustrates a second user interface according to an example embodiment. Reference to FIGS. 5 and 6 are described in the following discussion of the system described herein

In the examples illustrated in FIGS. 5 and 6, nine agro-based industries of Illinois were used to automate extraction of the physical flows and develop a PIOT. EMs for these nine industries were previously developed and were scaled to represent the industries in 2018 Illinois economy.

A user begins the process by uploading different EMs that are developed and primed to the system using the user interface, as illustrated in FIG. 5. The system is also capable of dealing with NAICS classification codes for EMs representing industrial sectors. Users can directly select the relevant preloaded NAICS code using the Sector Name drop-down list prompted while entering the sector name. Since EMs could also have many supporting files as per priming needs, the users may upload all files associated with an EM as a zip file, such as .csv, .py and aspen plus .bkp. For each EM upload, the system may allocate memory space, such as a directory in a file system or space in a database to be accessed by the MFDES job instance. Once all the EMs are uploaded and data input is complete, users submit the job using ‘Run’ button to start the simulations.

After submitting the job, MFDES initiates different simulating environments based on EM file extensions and proceeds as discussed in reference to FIGS. 1 and 2. Once simulation is complete, the GUI takes the user to the output tab. All the results generated by the PIOT-Hub can be directly viewed within the GUI as PST, PUT or PIOT. It also provides users with options to view and download the heatmap of the PIOT.

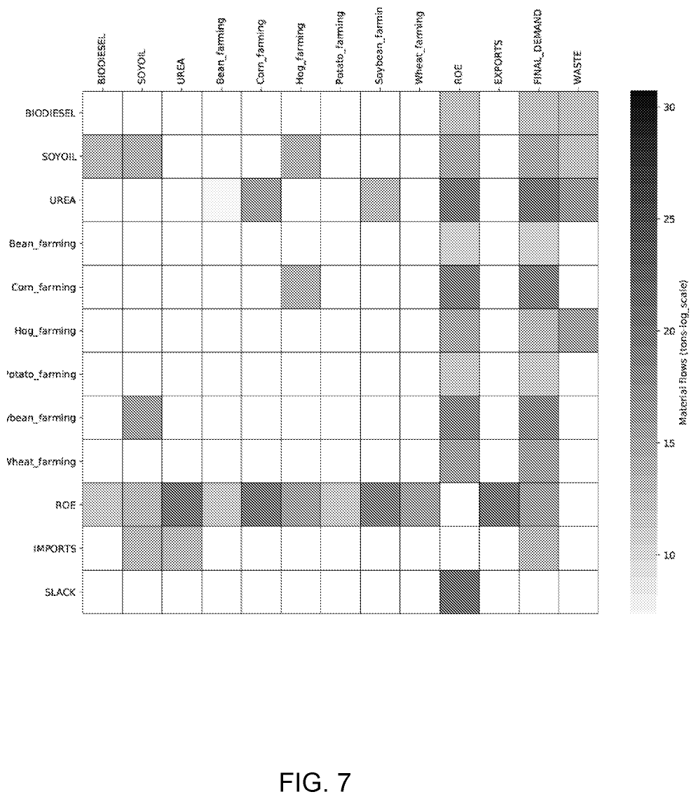

FIG. 7 illustrates an example of a heat map generated based on a PIOT. The heat map in FIG. 7 illustrates a PIOT for the modeled sectors in illinois generated using a simulation of EMs. The default units shown across all output tables is metric tons but could be different in other examples. Unless external information related to final demand, imports and exports is given, MFDES assigns all the unbalanced material flows to the rest of economy sector (RoE). If users also upload this information as a model file in the input window, MFDES will use that data to fill in respective columns and rows in the tables and the table format will be updated.

The heat map may shade the intersections of two industries or sectors with an intensity proportional to the amount of physical material flowing between the industries. Intersections of industries where there are greater flows of a material may have a darker shade or a different color than intersections of industries with lesser flows.

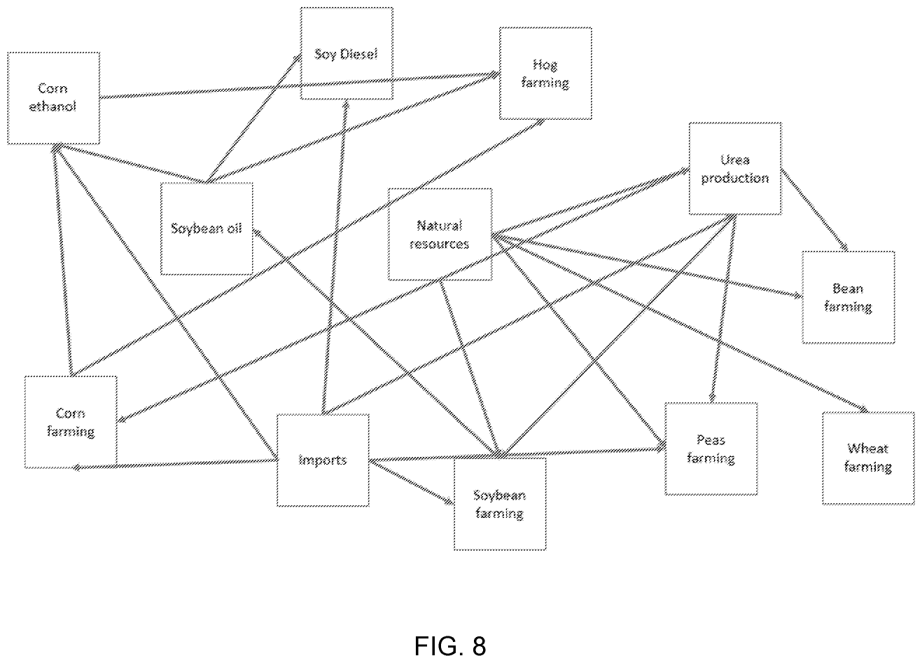

FIG. 8 illustrates an example of a PIOT network. The PIOT network includes nodes representative of sectors in an industry. The edges of the nodes may represent flows between the sectors. Arrows directed into the nodes may represent material inflow and flows directed away from a node may repellent material outflow. The PIOT network may be stored in memory as a data structure and/or rendered visually on a graphical user interface.

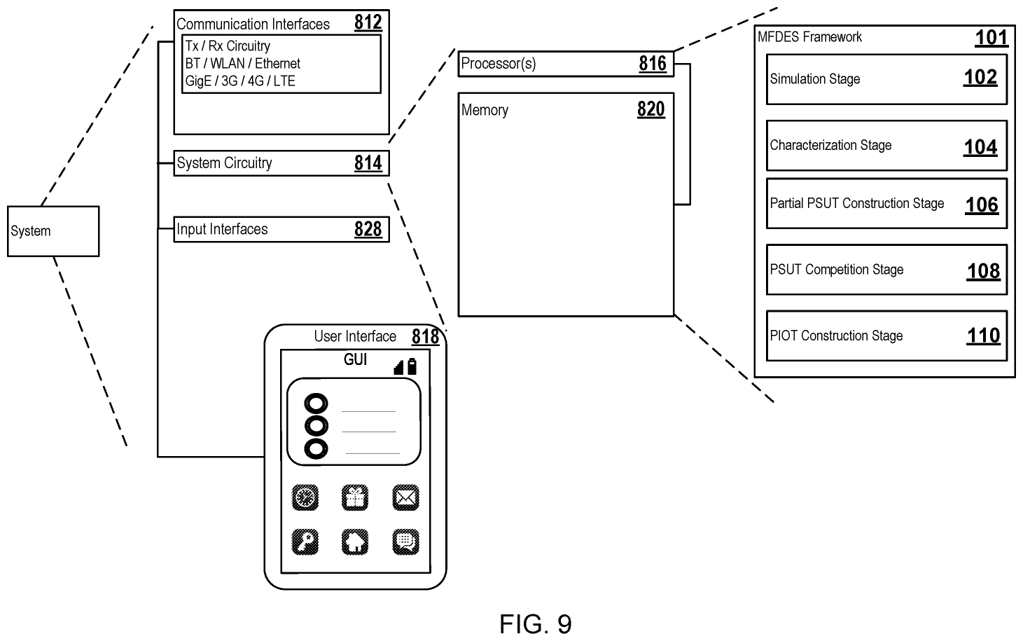

FIG. 9 illustrates a third example of the system 100. The system 100 may include communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations of the MFDES framework 101, one or more of the stages 102-110, and/or the system 100. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include the MFDES framework 101, one or more of the stages 102-110, and/or the system 100. Alternatively or in addition, the memory may include any other component or sub-component of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 100 may be implemented in many different ways. In some examples, the system 100 may be implemented with one or more logical components. For example, the logical components of the system 100 may be hardware or a combination of hardware and software. The logical components may include the MFDES framework 101, one or more of the stages 102-110, and/or the system 100. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, and/or other memory media. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A system, comprising:
a processor, the processor configured to:
receive an engineering model and an industry classification, the engineering model comprising executable instructions configured to simulate physical processes for an industry in an economy, wherein execution of the engineering generates a dataflow;
determine the type of engineering model, the type of engineering model associated with a flow type, the flow type being one from a group comprising commodity flow, raw material, and emission;
execute the engineering model to generate the flow data;
build an physical supply table (PST) and a physical use table (PUT) for a region of the economy, wherein to build the PST and PUT, the processor is configured to:
identify, based on the flow type and industry classification, a cell location in the PST, PUT, or a combination thereof, and
store the flow data based on the identified cell location; and
generating a physical input output table (PIOT) based on PSTs and PUTs generated for a plurality of industries; and
output the PIOT.

2. The system of claim 1, wherein to output the PIOT table, the processor is further configured to store the PIOT table in memory, display at least a portion of the PIOT table, communicate PIOT table over a network, or a combination thereof.

3. The system of claim 1, wherein the processor is further configured to:
determine an execution type associated with the engineering model, the execution type associated with a simulator configured to execute the engineering models;
select the simulator associated with the execution type; and
invoke the simulator to cause execution of the engineering model.

4. The system of claim 3, wherein to determine the execution type, the processor is further configured to identify the file extension of the engineering model.

5. The system of claim 1, wherein the processor is further configured to generate, based on the PIOT, a heatmap comprising cells shaded to illustrate material flow between two sectors/industries.

6. The system of claim 1, wherein the processor is further configured to:
access a trade and consumer demand data comprising export data, import data, and final consumer demand data;
populate the PUT with the export data and the final consumer demand data; and
populate the PST with the import data.

7. The system of claim 1, wherein the processor is further configured to:
generate a graphical user interface comprising a first control to receive a file identifier of the engineering model and a second control to receive the industry classification; and
receive the engineering model and industry classification in response to interaction with the graphical user interface.

8. A method, comprising:
receiving, via a graphical user interface, an engineering model and an industry classification, the engineering model comprising executable instructions configured to simulate physical processes for an industry in an economy, wherein execution of the engineering generates a dataflow;
determining the type of engineering model, the type of engineering model associated with a flow type and a flow direction, the flow type being one from a group comprising commodity flow, raw material, and emission, and the flow direction being an input or and output of the engineering model;
executing the engineering model to generate the flow data;
populating a physical supply table (PST) and a physical use table (PUT) for a region of the economy, the building comprising:
selecting the PST or the PUT, depending on the flow direction;
identifying, based on the flow type and industry classification, a cell location in the selected PST or PUT, and
storing the data in the selected PST or PUT based on the flow type and the industry classification; and
generating a physical input output table (PIOT) based on PUTs and PSTs generated based on a plurality of industries; and
outputing the physical input output table.

9. The method of claim 8, wherein outputing the PIOT table, the processor is further comprises displaying at least a portion of the PIOT table or communicating the PIOT table over a network.

10. The method of claim 8, further comprising:
determining an execution type associated with the engineering model, the execution type associated with a simulator configured to execute the engineering models;
selecting the simulator associated with the execution type; and
invoking the simulator to cause execution of the engineering model.

11. The method of claim 10, wherein determining the execution type further comprises:
identifying a file extension of the engineering model.

12. The method of claim 8, further comprising:
generating, based on the PIOT, a heatmap comprising cells shaded to illustrate material flow between two sectors.

13. The method of claim 8, further comprising:
access a trade and consumer demand data comprising exports, imports, and final consumer demand; and
populate the PUT with the export data and the final consumer demand data; and
populate the PST with the import data.

14. The method of claim 8, further comprising:
generating a graphical user interface comprising a first control to receive a file identifier of the engineering model and a second control to receive the industry classification; and
receiving the engineering model and industry classification in response to interaction with the graphical user interface.

15. A non-transitory computer-readable storage medium, comprising:
a plurality of instructions executable by a hardware processor, the instruction causing the hardware processor to:
receive an engineering model and an industry classification, the engineering model comprising executable instructions configured to simulate physical processes for an industry in an economy, wherein execution of the engineering generates a dataflow;
determine the type of engineering model, the type of engineering model associated with a flow type, the flow type being one from a group comprising commodity flow, raw material, and emission;
cause execution of the engineering model to generate the flow data;
build an PSUT where the flow data is organized in the PSUT based on the flow type and industry classification, the PSUT comprising an a physical use table (PUT) and a physical supply table (PST);
generate a physical input output table (PIOT) based on PSUTs generated for a plurality of industries; and
output the physical input output table.

16. The non-transitory computer-readable storage medium of claim 15, further comprising:
instructions executable by the processor to store the PIOT table in memory, display at least a portion of the PIOT table, communicate PIOT table over a network, or a combination thereof.

17. The non-transitory computer-readable storage medium of claim 15, further comprising:
instructions executable by the processor to determine an execution type associated with the engineering model, the execution type associated with a simulator configured to execute the engineering models;
instructions executable by the processor to select the simulator associated with the execution type; and
instructions executable by the processor to invoke the simulator to cause execution of the engineering model.

18. The non-transitory computer-readable storage medium of claim 17, wherein the instructions executable by the processor to determine an execution type further comprise:
instructions executable by the processor to identify the file extension of the engineering model.

19. The non-transitory computer-readable storage medium of claim 15, further comprising:
instructions executable by the processor to generate, based on the PIOT, a heatmap comprising cells shaded to illustrate material flow between two sectors.

20. The non-transitory computer-readable storage medium of claim 15, further comprising:
instructions executable by the processor to generate a graphical user interface comprising a first control to receive a file identifier of the engineering model and a second control to receive the industry classification; and
instructions executable by the processor to receive the engineering model and industry classification in response to interaction with the graphical user interface.
